(19) United States
(12) Patent Application Publication
(10) Pub. No.: US 2026/0156205 A1
(43) Pub. Date: Jun. 4, 2026

(54) COMMUNICATION APPARATUS, PROCESSING METHOD FOR COMMUNICATION APPARATUS, AND STORAGE MEDIUM

(71) Applicant: CANON KABUSHIKI KAISHA, Tokyo (JP)

(72) Inventor: SATORU TSUBOI, Kanagawa (JP)

(21) Appl. No.: 19/177,395

(22) Filed: Apr. 11, 2025

(30) Foreign Application Priority Data
Apr. 16, 2024 (JP) 2024-066166

(51) Int. Cl. H04L 69/22; H04J 3/06

(52) U.S. Cl. CPC H04L 69/22; H04J 3/0667

(57) ABSTRACT

A communication apparatus includes a detection unit configured to detect writing or reading of a predetermined packet based on a signal of a channel for writing a packet received from an outside into a memory unit, or a signal of a channel for transmitting a packet read from a memory unit to an outside, and a time holding unit configured to, in a case where writing or reading of the predetermined packet is detected, hold a current time of a clock unit as a write hold time or a read hold time.

### BACKGROUND

### Field of the Disclosure

The present disclosure relates to a communication apparatus, a processing method for a communication apparatus, and a storage medium.

### Description of the Related Art

In recent years, a technique for performing time synchronization between a plurality of devices connected via a network has been used in various fields. As a technique for performing time synchronization between a plurality of terminals, a precision time protocol (hereinafter, PTP) has been widely used.

In the PTP, a current time (time stamp) at which a time synchronization source terminal and a time synchronization destination terminal transmit and receive a predetermined PTP packet is acquired, and a network delay time (one-way transmission time) between the terminals is calculated using the time stamp. Then, the time synchronization destination terminal calculates a time difference from the time synchronization source terminal based on the network delay time, and synchronizes with the time synchronization source by correcting its own clock.

Japanese Patent Application Laid-Open No. 2009-111654 discusses a technique for performing time synchronization by acquiring a time stamp at the time of wireless communication.

In the time synchronization that uses the PTP, it has been known that, as an acquisition timing of the time stamp is closer to a network lower layer such as a physical (PHY) layer or a media access control (MAC) layer, time synchronization can be performed more accurately.

If the acquisition timing is at a higher layer, the time stamp includes not only a fluctuation in transmission time that is caused when a packet flows on a network, but also a fluctuation in memory access within a terminal and a fluctuation caused by a central processing unit (CPU) processing. As these fluctuation times get longer, time synchronization accuracy deteriorates.

For this reason, some of wireless communication chips that perform processing of lower layers and network interface cards (which, hereinafter, will be referred to as an NICs) have a function of acquiring a time stamp at the time of packet transmission and reception.

Nevertheless, in a case where a communication chip or an NIC having this function is unavailable, a time stamp is acquired at a timing at which a transmission start of a PTP packet is detected in a higher layer or a timing at which the reception of a PTP packet is detected.

That is, a time stamp acquired at the time of reception includes a memory access latency until a PTP packet received from a communication chip or an NIC is written into a memory region, such as a dynamic random access memory (DRAM), of the terminal itself.

A time stamp acquired at the time of transmission includes a time until a PTP packet included in a memory region, such as a DRAM, of the terminal itself is delivered to a communication chip or an NIC. These fluctuations lead to a deterioration in synchronization accuracy.

### SUMMARY

Embodiments of the present disclosure are directed to enabling a time at which a packet is received, or a time at which a packet is transmitted, to be held with a small error.

According to an aspect of the present disclosure, a communication apparatus includes a detection unit configured to detect writing or reading of a predetermined packet based on a signal of a channel for writing a packet received from an outside into a memory unit, or a signal of a channel for transmitting a packet read from a memory unit to an outside, and a time holding unit configured to, in a case where writing or reading of the predetermined packet is detected, hold a current time of a clock unit as a write hold time or a read hold time.

Further features of various embodiments will become apparent from the following description of exemplary embodiments with reference to the attached drawings.

### BRIEF DESCRIPTION OF THE DRAWINGS

FIG. 1 is a diagram illustrating a configuration example of a communication system.

FIG. 2 is a diagram illustrating a configuration example of a digital camera.

FIG. 3A is a diagram illustrating signals of a valid-ready protocol.

FIG. 3B is a diagram illustrating signals of the valid-ready protocol.

FIG. 4 is a diagram illustrating channels to be used for connection between a direct memory access (DMA) unit and a system bus.

FIG. 5 is a diagram illustrating signals to be taken in by a time management unit as monitoring signals.

FIG. 6 is a diagram illustrating a configuration example of the time management unit.

FIG. 7 is a flowchart illustrating an operation of a write data channel analysis unit.

FIG. 8 is a flowchart illustrating an operation of a read request channel analysis unit.

FIG. 9 is a flowchart illustrating an operation of a read response channel analysis unit.

FIG. 10 is a flowchart illustrating an operation of a clock unit.

FIG. 11 is a flowchart illustrating an operation of a time holding unit.

FIG. 12 is a diagram illustrating a configuration example of a digital camera.

FIG. 13 is a diagram illustrating a configuration example of a DMA unit.

FIG. 14 is a diagram illustrating a precision time protocol (PTP) time synchronization processing.

### DESCRIPTION OF THE EMBODIMENTS

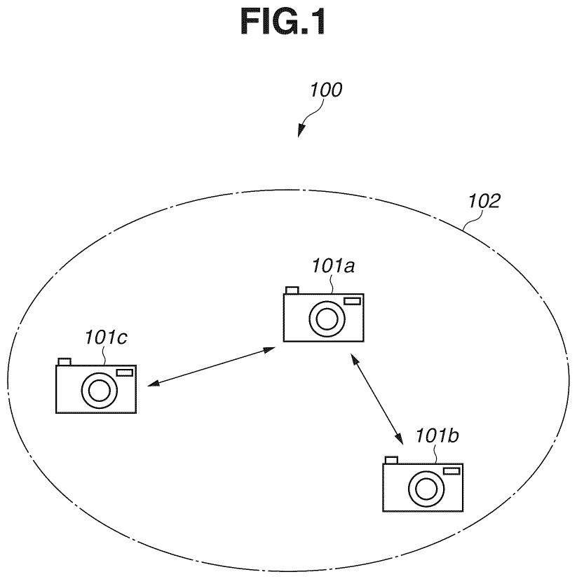

FIG. 1 is a diagram illustrating a configuration example of a communication system 100 according to a first exemplary embodiment. The communication system 100 includes digital cameras 101a, 101b, and 101c, and a wireless local area network (LAN) network 102.

Hereinafter, the digital cameras 101b and 101c participate in the wireless LAN network 102 formed by the digital camera 101a operating as an access point. The digital camera 101a performs time synchronization in compliance with a precision time protocol (PTP), with the digital cameras 101b and 101c that have participated in the wireless LAN network 102.

In the present exemplary embodiment, the digital camera 101a operates as a time synchronization source (primary terminal) in the time synchronization, and the digital cameras 101b and 101c operate as a time synchronization destination (secondary terminal).

Hereinafter, in a case where no distinction is made among the digital cameras 101a, 101b, and 101c, these will be described as the digital cameras 101, and alphabets will be omitted.

By the digital cameras 101a to 101c generating timing signals for image capturing, based on a synchronized time, all the digital cameras 101a to 101c become capable of performing image capturing at the same timing (synchronous image capturing).

The description will be given assuming that apparatuses included in the communication system 100 according to the present exemplary embodiment are the digital cameras 101, but the apparatuses may be other apparatuses such as a smartphone, a personal computer (PC), a video camera, a smartphone, and a drone. The digital camera 101 is an example of a communication apparatus.

The number of apparatuses included in the communication system 100 is three, but may be two or four or more. The timing signal can be used also by an application other than an image capturing application. For example, such an application includes an application operating while making cooperation between a plurality of drone apparatus.

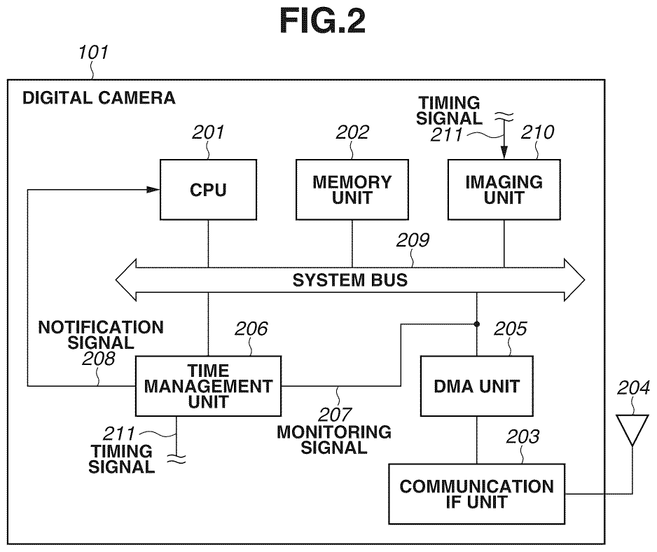

FIG. 2 is a diagram illustrating a configuration example of the digital camera 101 illustrated in FIG. 1. The digital camera 101 includes a CPU 201, a memory unit 202, a communication interface (IF) unit 203, an antenna 204, a direct memory access (DMA) unit 205, a time management unit 206, a system bus 209, and an imaging unit 210.

The CPU 201, the memory unit 202, the DMA unit 205, and the time management unit 206 are connected to the system bus 209. FIG. 2 illustrates one connection between each functional unit and the system bus 209, but two or more connections may be established between each functional unit and the system bus 209 according to application. For example, the DMA unit 205 has two interfaces in total for connecting with the system bus 209, which include an interface intended for data transfer, and an interface intended for accessing a register for controlling the DMA unit 205.

The CPU 201 is a processing unit that controls the entire digital camera 101, and performs time synchronization processing (protocol processing of the PTP) by communicating PTP packets with other digital cameras 101. In a case where the digital camera 101 operates as a secondary terminal, the CPU 201 performs time synchronization with a clock included in a primary terminal, by correcting a time of a clock included in the time management unit 206, during a process of the time synchronization processing.

The memory unit 202 is a memory that holds programs of the CPU 201 and PTP packets to be transmitted and received. FIG. 2 illustrates an example including only one memory unit 202, but a plurality of memory units 202 may be included in a divisional manner according to application, and types of memories may be changed according to application.

The communication IF unit 203 is a functional unit that performs the transmission and the reception of communication packets with the other digital cameras 101 via the antenna 204.

The DMA unit 205 transfers a communication packet received from the communication IF unit 203, to the memory unit 202, and reads a communication packet to be delivered to the communication IF unit 203, from the memory unit 202. Examples of an IF standard of connection between the DMA unit 205 and the communication IF unit 203 include a peripheral component interconnect-express (hereinafter, PCIe). Alternatively, a connection IF standard may be a secure digital input/output (hereinafter, SDIO) or a universal serial bus (USB).

The time management unit 206 takes in, as monitoring signals 207, a part of signals of IF connection between the system bus 209 and the DMA unit 205. In a case where the monitoring signal 207 satisfies a predetermined condition, the time management unit 206 holds a time of a clock included in the time management unit 206, and makes a notification to the CPU 201 by outputting a notification signal 208. The details will be described below. The time management unit 206 also has a function of generating a timing signal 211 based on the time of the clock included in the time management unit 206.

The imaging unit 210 is a functional unit that performs image capturing upon detecting a rising edge or a falling edge of the timing signal 211. Captured image data obtained by the imaging unit 210 is once held in the memory unit 202, and then saved by the CPU 201 into an external medium (not illustrated) such as a memory card. Alternatively, the CPU 201 may be configured to control captured image data obtained by the imaging unit 210, to be transferred not to an external medium (not illustrated) but to another terminal via the communication IF unit 203.

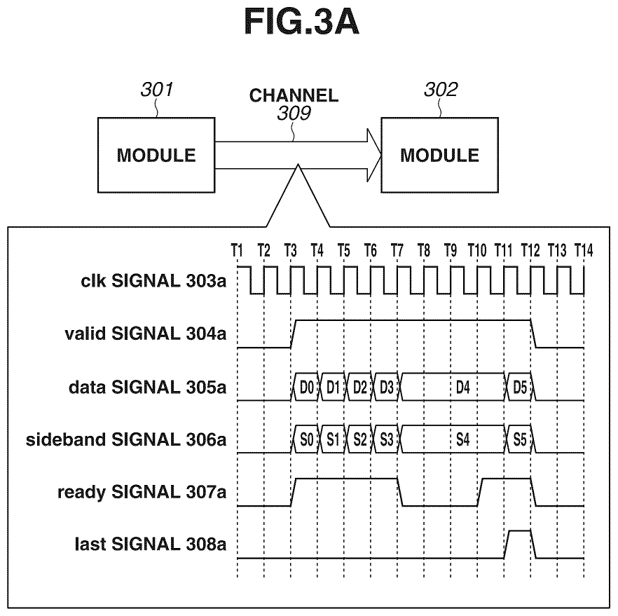

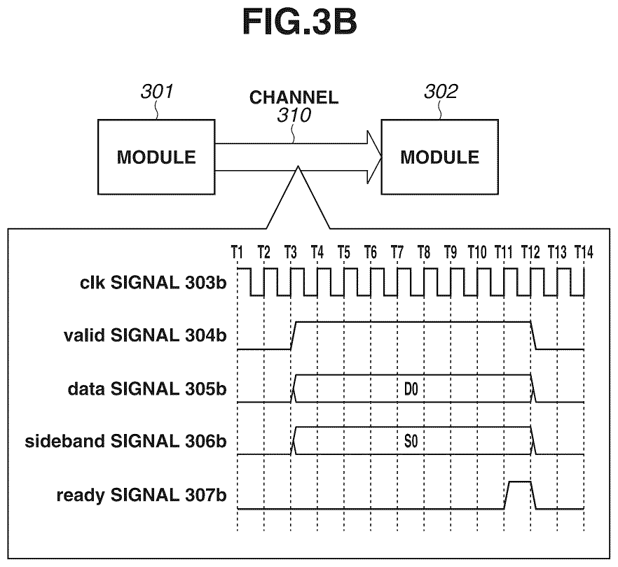

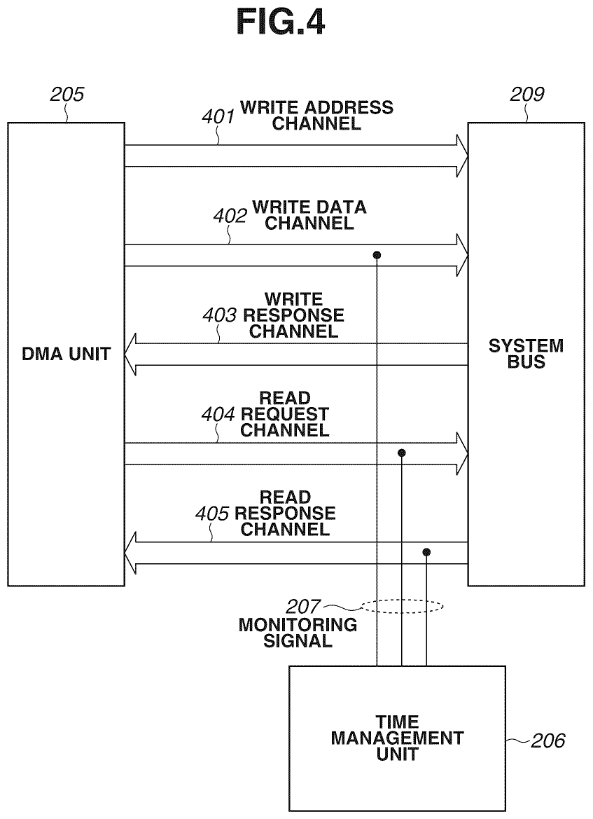

The system bus 209 connects between functional blocks. Here, a basic protocol (valid-ready protocol) to be used for connection between the system bus 209 and each functional block will be described with reference to FIGS. 3A and 3B, and channels to be used for connection between the DMA unit 205 and the system bus 209 will be described with reference to FIG. 4.

FIG. 3A illustrates signals to be used when data transfer is performed from a module 301 to a module 302, and the signals are defined as a channel 309.

The channel 309 includes a clk signal 303a, a valid signal 304a, a data signal 305a, a sideband signal 306a, a ready signal 307a, and a last signal 308a.

FIG. 3A illustrates input-output of the clk signal 303a between the module 301 and the module 302 although the input-output does not occur therebetween because the clk signal 303a, which is an operation clock, is supplied to both of the module 301 and the module 302.

The valid signal 304a, the data signal 305a, the sideband signal 306a, and the last signal 308a are generated by the module 301 and output to the module 302. The ready signal 307a is generated by the module 302 and output to the module 301.

Each signal will be described. In a case where the valid signal 304a is at a high level, this means that data to be delivered exists. In a case where the ready signal 307a is at the high level, this means that data can be received. The data signal 305a means data to be delivered, as the name suggests, and normally includes a plurality of bits and bits of multiples of 8.

The sideband signal 306a is additional information accompanying the data signal 305a, and is byte enable information, for example. In a case where the last signal 308a is at the high level, it indicates that the currently-out data signal 305a (and the sideband signal 306a) is the last of one block of data pieces delivered over a plurality of cycles.

When both of the valid signal 304a and the ready signal 307a output by the respective modules reach the high level, data reception of the data signal 305a, the last signal 308a, and the sideband signal 306a is completed. Then, a value becomes able to be updated in the next clock cycle. When the ready signal 307a is at a low level while the valid signal 304a is at the high level, a data output side needs to output the data signal 305a, the last signal 308a, and the sideband signal 306a with the same values also in the next cycle.

In a lower part in FIG. 3A, a waveform of one data output (input) from the module 301 to the module 302 is illustrated. Because the ready signal 307a remains at the low level during a period from times T8 to T10, the values of the data signal 305a, the last signal 308a, and the sideband signal 306a do not change during the period. A plurality sideband signals 306a may be defined according to application, or the sideband signal 306a may be omitted.

FIG. 3B also illustrates signals to be used when data transfer is performed from the module 301 to the module 302, and a bundle of the signals is defined as a channel 310. Unlike FIG. 3A, the channel 310 includes no last signal in FIG. 3B. Because the remaining signals in FIG. 3B are equivalent to those in FIG. 3A, the signals are indicated by the same numbers with different alphabets.

The channel 310 includes a clk signal 303b, a valid signal 304b, a data signal 305b, a sideband signal 306b, and a ready signal 307b.

In a lower part in FIG. 3B, a waveform of one data output (input) from the module 301 to the module 302 is illustrated. Because the ready signal 307b remains at the low level during a period from time T4 to T11, the values of the data signal 305b and the sideband signal 306b do not change during the period.

Hereinafter, in a case where no distinction is made among the valid signals 304, the data signals 305, the sideband signals 306, the ready signals 307, and the last signals 308, only the allocated numbers will be described, and the alphabets will be omitted. In the channel 310 in FIG. 3B, one piece of data indicates one block unit.

Subsequently, FIG. 4 illustrates five channels 401 to 405 for connection between the DMA unit 205 and the system bus 209. Among the five channels 401 to 405, a write address channel 401, a write response channel 403, and the read request channel 404 include no last signal 308 similarly to the above-described channel 310. A write data channel 402 and a read response channel 405 being the remaining two channels include the last signals 308 similarly to the channel 309.

Among these five channels 401 to 405, signals to be taken in by the time management unit 206 as the monitoring signals 207 are signals used in the write data channel 402, the read request channel 404, and the read response channel 405.

The DMA unit 205 manages data transfer executed via the system bus 209, assuming that the five channels 401 to 405 correspond to one set of interface signals.

The channels 401 to 405 are channels between the DMA unit 205 and the system bus 209. The DMA unit 205 is a direct memory access unit.

The write address channel 401 is used to transmit address information to be written, as the data signal 305. The write address channel 401 also designates an amount of data to be written, using the sideband signal 306, and designates information indicating access is cache access or secure access, using another sideband signal 306.

The write data channel 402 is used to transmit data to be written into an address designated by the write address channel 401, as the data signal 305. The write data channel 402 also designates an effective region of data to be written, using the sideband signal 306 (byte enable). The number of cycles required until the last signal 308 reaches the high level is preliminarily designated as an “amount of data to be written”, using the sideband signal 306 of the write address channel 401.

The write response channel 403 is used to transmit information indicating whether information designated by the write address channel 401 and the write data channel 402 has been correctly written.

The read request channel 404 is used to transmit an address desired to be read, as the data signal 305. The read request channel 404 also designates an amount of data to be read, using the sideband signal 306, and designates information indicating access is cache access or secure access, using another sideband signal 306.

The read response channel 405 is used to transmit data information of the address designated by the read request channel 404, using the data signal 305, and byte enable information does not exist in the sideband signal 306 of the read response channel 405. The number of cycles required until the last signal 308 reaches the high level is preliminarily designated as an “amount of data to be read”, using the sideband signal 306 of the read request channel 404.

When the value of the data signal 305 of the read request channel 404 does not match the alignment of the system bus 209, as the data signal 305 to be received in the read response channel 405, data starting from a region where an alignment is made is received. That is, when a bus width of the system bus 209 is eight bytes, if a request is issued to read data from an address 0x15, the read response channel 405 returns the data signal 305 from an address 0x8 in an 8-byte unit. A functional block that generates a read request determines an effective region of the received data signal 305 based on the requested address.

Examples of bus protocols that manage address information and data information in different channels as described above include an advanced extensible interface (AXI). The present exemplary embodiment is applicable also to the bus protocol of the AXI, and other bus protocols that manage address information and data information in different channels are also applicable as long as the above-described specification is satisfied.

The DMA unit 205 includes two interfaces for connecting with the system bus 209, and the DMA unit 205 includes ten channels in total between itself and the system bus 209.

Because the time management unit 206 performs the detection of a PTP packet from signals taken in, signals to be used in channels of interfaces to be used for data transfer application are connected as the monitoring signals 207.

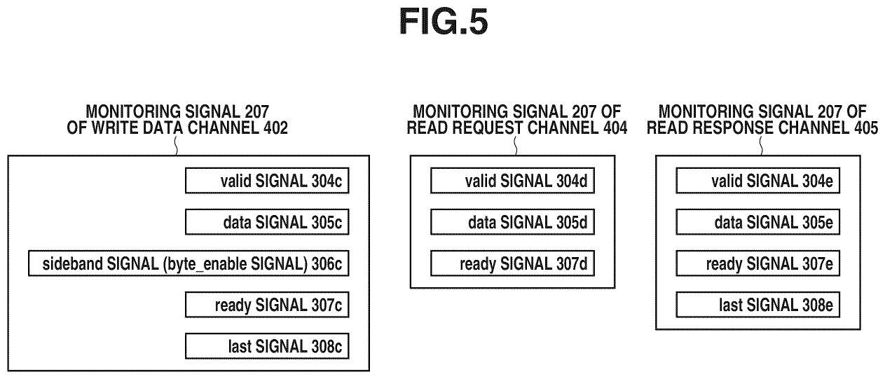

Because a data string of a communication packet is normally handled in a network byte endianness, among pieces of information to be taken in using the monitoring signal 207, the data signal 305c and the data signal 305e in FIG. 5 need to be handled in the network byte endianness. That is, lower bit sides of the data signal 305c and the data signal 305e correspond to information regarding the leading side of the communication packet.

FIG. 5 illustrates signals to be taken in by the time management unit 206 as the monitoring signals 207.

The monitoring signals 207 of the write data channel 402 are five types including a valid signal 304c, a data signal 305c, a sideband signal (byte_enable signal) 306c, a ready signal 307c, and a last signal 308c. The time management unit 206 takes in only a sideband signal (byte_enable signal) 306c indicating byte enable, among a plurality of sideband signals 306.

The monitoring signals 207 of the read request channel 404 are three types including a valid signal 304d, a data signal 305d, and a ready signal 307d.

The monitoring signals 207 of the read response channel 405 are four types including a valid signal 304e, a data signal 305e, a ready signal 307e, and a last signal 308e.

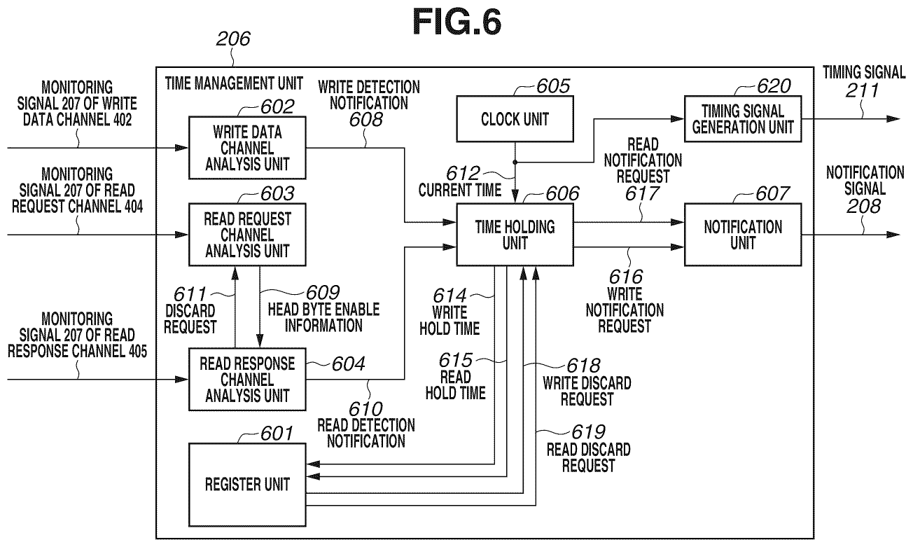

Subsequently, an internal block configuration of the time management unit 206 will be described with reference to FIG. 6. A register unit 601 connects with the system bus 209, and manages control information of the time management unit 206 that is set by the CPU 201 in FIG. 2. The control information includes information regarding module start and stop, a condition of a PTP packet to be detected using the monitoring signal 207, correction information of a clock unit 605, and output start time information of the timing signal 211.

In a case where the CPU 201 reads a time stamp of a transmission/reception packet held in the time management unit 206, from the register unit 601, a write hold time 614 and a read hold time 615 output by a time holding unit 606 can be read.

Because these time stamps continue to remain inside unless the CPU 201 issues a discard command via the register unit 601, the CPU 201 needs not always start an operation of acquiring a time stamp, at a timing at which the notification signal 208 is received. If a time stamp is read at a timing at which transmission completion or reception completion of a packet is detected, time synchronization accuracy does not deteriorate.

If the CPU 201 issues a discard request of a time stamp of a transmission/reception packet held in the time management unit 206, the register unit 601 outputs a write discard request 618 and a read discard request 619 to the time holding unit 606. Each functional block in the time management unit 206 can always refer to control information set in the register unit 601.

A write data channel analysis unit 602 performs the detection of a PTP packet using the monitoring signal 207 of the write data channel 402. If the write data channel analysis unit 602 detects a PTP packet, the write data channel analysis unit 602 outputs a write detection notification 608 to the time holding unit 606. A condition for detecting a PTP packet will be described below when an operation flow of the write data channel analysis unit 602 is described.

A read request channel analysis unit 603 calculates byte enable regarding head data of read response data, using the monitoring signal 207 of the read request channel 404. Information regarding the calculated byte enable is held in a FIFO_A (not illustrated) included in the read request channel analysis unit 603. In a case where one or more pieces of data are stored in the FIFO_A, the FIFO_A continues to output oldest data until an extraction request is received.

An output value of the FIFO_A is output to a read response channel analysis unit 604 as head byte enable information 609. The FIFO_A is updated (switches to output the second oldest data by deleting the oldest data) when a discard request 611 received from the read response channel analysis unit 604 is detected. The details of the operation flow of the read request channel analysis unit 603 will be described below.

The read response channel analysis unit 604 performs the detection of a PTP packet using the head byte enable information 609 and the monitoring signals 207 of the read response channel 405. If the read response channel analysis unit 604 detects a PTP packet, the read response channel analysis unit 604 outputs the write detection notification 608 to the time holding unit 606. A method of detecting a packet as a PTP packet is basically similar to a detection method used by the write data channel analysis unit 602.

The clock unit 605 includes therein a counter indicating a current time. If the digital camera 101 is a secondary terminal, the CPU 201 corrects a time of a clock included in the time management unit 206, via the register unit 601, during the process of time synchronization processing. That is, the CPU 201 changes a value of the counter of the clock unit 605, issues an instruction to add or subtract a designated value to or from the current counter, or changes an increment value of the counter. The clock unit 605 constantly outputs a current time 612 indicating a counter value, to the time holding unit 606 and a timing signal generation unit 620.

When the time holding unit 606 detects the write detection notification 608, the time holding unit 606 stores the value of the current time 612 into a FIFO_B (not illustrated) included in the time holding unit 606. When the time holding unit 606 receives a read detection notification 610, the time holding unit 606 also stores the value of the current time 612 into a FIFO_C (not illustrated) included in the time holding unit 606.

Similarly to the FIFO_A, in a case where one or more pieces of data are stored in each of the FIFO_B and the FIFO_C, the FIFO_B and the FIFO_C continue to output oldest data until an extraction request is received. The stored data to be outputted by the FIFO_B is handled as the write hold time 614. The stored data to be outputted by the FIFO_C is handled as the read hold time 615.

The FIFO_B is updated when the write discard request 618 output by the register unit 601 is detected. The FIFO_C is updated when the read discard request 619 output by the register unit 601 is detected.

Simultaneously with storing the value of the current time 612 into the FIFO_B or the FIFO_C, the time holding unit 606 outputs a read notification request 617 or a write notification request 616 to a notification unit 607.

If the notification unit 607 receives the read notification request 617 or the write notification request 616, the notification unit 607 outputs the notification signal 208. The notification signal 208 is used to notify that the time management unit 206 has held a time stamp indicting a time at which a PTP packet is transmitted or a time at which a PTP packet is received, therein. The notification signal 208 can be canceled by the register unit 601. The notification unit 607 may be configured to include status information notifying the register unit 601 that the time stamp has been held therein, without generating the notification signal 208.

The timing signal generation unit 620 outputs the timing signal 211 at a timing at which the current time 612 output by the clock unit 605 reaches an output start time of the timing signal 211 that is held in the register unit 601.

The timing signal 211 may be a signal having a fixed cycle, a signal outputting 1 until a cancel instruction is issued, like an interrupt signal, or a signal outputting 1 during a period corresponding to one to several cycles. Alternatively, the timing signal 211 may have a configuration with inverted polarity (outputting 1 until the output start time, and outputting 0 if the current time reaches the output start time). In a case where the timing signal 211 has a fixed cycle, the fixed cycle is designated in the register unit 601.

In the present exemplary embodiment, the number of timing signals 211 is one, but the number of timing signals 211 may increase in accordance with the types of corresponding applications. In this case, different timing signals 211 are connected to processing units of the respective applications.

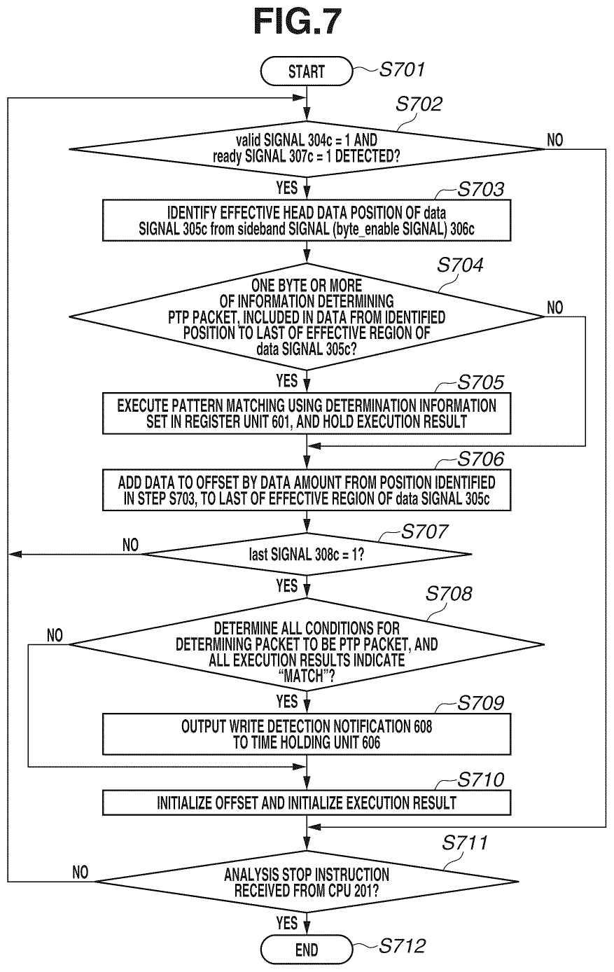

Next, an operation flow of the write data channel analysis unit 602 will be described with reference to FIG. 7. In this flow, the start of the processing in step S701 is performed when the power of the digital camera 101 is turned on and an analysis start instruction is detected by the CPU 201. The processing is started in a state where an offset of a variable and an execution result that are to be used in this flow are initialized.

A default value of the offset is set to 0, and a default value of the execution result is set to information indicating “mismatched”. This flow operates based on a clock signal supplied to the write data channel analysis unit 602, and operates from steps S702 to S702 (return in the case of NO in step S707 or S711) or from steps S702 to S712 in one cycle. As a matter of course, the processing of this flow may be operated in a plurality of cycles by dividing the processing into a plurality of blocks and pipeline-operating the processing.

The write data channel analysis unit 602 inputs the monitoring signal 207 of the write data channel 402. The write data channel 402 is a channel for writing a packet received from the outside via the communication IF unit 203 into the memory unit 202. Hereinafter, a processing method of the digital camera 101 will be described.

In step S702, the write data channel analysis unit 602 determines whether the valid signal 304c=1 and the ready signal 307c=1 have been detected. In a case where the valid signal 304c=1 and the ready signal 307c=1 have been detected (YES in step S702), the processing proceeds to step S703. In a case where the valid signal 304c=1 and the ready signal 307c=1 have not been detected (NO in step S702), the processing proceeds to step S711.

In step S703, the write data channel analysis unit 602 identifies an effective head data position of the data signal 305c from the sideband signal (byte_enable signal) 306 c. For example, if a data width is 64 bits and the sideband signal (byte_enable signal) 306 c is 0xF0, among zeroth to (lower bit side) to seventh (higher bit side) bytes, a fourth byte becomes the effective head data position.

Here, the effective head data position indicates a head position of effective data. The byte_enable signal is an example of byte enable information.

In step S704, the write data channel analysis unit 602 determines whether one byte or more of information determining a PTP packet is included in data from the position identified in step S703, to the last of an effective region of the data signal 305c. In a case where one byte or more of information determining a PTP packet is included (YES in step S704), the processing proceeds to step S705. In a case where one byte or more of information determining a PTP packet is not included (NO in step S704), the processing proceeds to step S706.

Here, the information determining a PTP packet will be described. When a PTP packet flows on a network, conceivable configurations of the PTP packet mainly include three patterns.

The first pattern corresponds to a case where an Ethernet header, a PTP header, and a PTP payload are included in this order from the head of the packet (hereinafter, pattern 1).

The second pattern corresponds to a case where an Ethernet header, an Internet Protocol version 4(IPv4 ) header, a user datagram protocol (UDP) header, a PTP header, and a PTP payload are included in this order from the head of the packet (hereinafter, pattern 2).

The third pattern corresponds to a case where an Ethernet header, an Internet Protocol version 6(IPv6 ) header, a UDP header, a PTP header, and a PTP payload are included in this order from the head of the packet (hereinafter, pattern 3).

Because the present exemplary embodiment is used in wireless communication, a wireless header unique to a wireless chip vendor is added before an Ethernet header. That is, for example, in the pattern 1, a wireless header, an Ethernet header, a PTP header, and a PTP payload are included in this order from the head of the packet, and a wireless header region is added to the head of the packet.

The CPU 201 preliminarily designates a pattern of a packet to be detected, from among these three patterns, and preliminarily designates a wireless header length, using the register unit 601. As a matter of course, the time management unit 206 may be implemented in such a manner that all the patterns can be handled.

In the pattern 1, the information determining a PTP packet corresponds to at least two header regions. The first header region is an Ether Type region of the Ethernet header, and the second header region is a message Type region of the PTP header (lower four-bit information of the beginning one byte of the PTP header).

In the pattern 2, the information determining a PTP packet corresponds to at least four header regions. The first header region is an Ether Type region of the Ethernet header, the second header region is a Protocol region of the IPv4 header, the third header region is a Destination Port region of the UDP header, and the fourth header region is a message Type region of the PTP header.

In the pattern 3, the information determining a PTP packet corresponds to at least four header regions. The first header region is an Ether Type region of the Ethernet header, the second header region is a Next Header region of the IPv6 header, the third header region is a Destination Port region of the UDP header, and the fourth header region is a message Type region of the PTP header.

In these three patterns, other regions such as a Destination MAC Address region of the Ethernet header and a Destination Address region of the IPv4 header may also be used. As the number of regions used in detection becomes larger, an advantage of decreasing a probability of false detection is obtained. By using these regions, it becomes possible to add determination that uses a multicast address to be used in the PTP.

In the above-described three patterns, the information determining a PTP packet in step S704 is a value of a region from the head of the PTP packet to the message Type region of the PTP header.

The write data channel analysis unit 602 determines whether one byte or more of these header regions are included, using information regarding the data signal 305c and the sideband signal (byte_enable signal) 306c. To make the determination, it is necessary to manage a position of data flowing on the monitoring signal 207 of the write data channel 402, the position from the head of the current packet, and manages the position using a variable offset initialized in step S701.

The write data channel analysis unit 602 can determine whether a position has reached a desired header region, from the value of offset and an amount of data up to the last of an effective region. That is, when the offset is 0, this means that the processing starts from the head of the packet, and when the offset is N, this means that the processing starts from a location advanced from the head of the packet by N bytes.

The calculation of the offset will be described with reference to step S706, and a value to be actually determined will be described with reference to step S705. Because a region of each header has a known data size, the write data channel analysis unit 602 can determine whether a position has reached a region of each header.

In step S705, the write data channel analysis unit 602 executes pattern matching on the information determining a PTP packet in step S704 using determination information set in the register unit 601, holds an execution result, and the processing proceeds to step S706. The determination information includes expected values of a plurality of regions to be used in the above-described three patterns. Executing pattern matching means determining whether the information determining a PTP packet matches an expected value.

In the pattern 1, an expected value of the Ether Type region of the Ethernet header is 0x88F7, and an expected value of the message Type region of the PTP header is any of 0x0 to 0x3. The message Type=0x0 means that the type of the PTP packet is Sync. The message Type=0x1 means that the type of the PTP packet is delay_req. The message Type=0x2 means that the type of the PTP packet is Pdelay_req. The message Type=0x3 means that the type of the PTP packet is Pdelay_resp. Because these four types require a time stamp in the PTP, determination by pattern matching is performed.

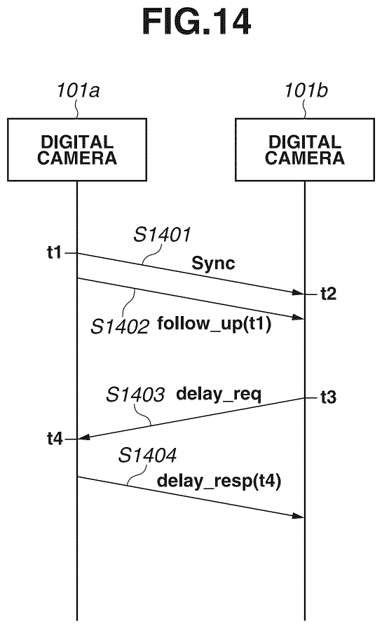

An expected value of the message Type region of the PTP header may be set to any of 0x0, 0x1, 0x8, and 0x9. The message Type=0x0 means that the type of the PTP packet is Sync (FIG. 14). The message Type=0x1 means that the type of the PTP packet is delay_req (FIG. 14). The message Type=0x8 means that the type of the PTP packet is follow_up (FIG. 14). The message Type=0x9 means that the type of the PTP packet is delay_resp (FIG. 14).

In the pattern 2, an expected value of the Ether Type region of the Ethernet header is 0x0800. An expected value of the Protocol region of the IPv4 header is 0x11. An expected value of the Destination Port region of the UDP header is either one of 319 and 320. An expected value of the message Type region of the PTP header is any of 0x0 to 0x3.

In the pattern 3, an expected value of the Ether Type region of the Ethernet header is 0x86DD. An expected value of the Next Header region of the IPv6 header is 0x11. An expected value of the Destination Port region of the UDP header is either one of 319 and 320. An expected value of the message Type region of the PTP header is any of 0x0 to 0x3.

In a case where a plurality of expected values exists in one region, it is sufficient that a value matches any of these expected values. That is, OR determination is performed as pattern matching of an expected value.

While these pieces of determination information (expected values) may be held by the time management unit 206 as fixed values, by enabling the register unit 601 to change the determination information, there is room for flexible support for a future specification change.

A channel where a PTP packet requiring a time stamp appears varies between a primary terminal and a secondary terminal. In the primary terminal, because a Sync packet (FIG. 14) of the PTP is transmitted, the detection of the Sync packet of the PTP is performed in a channel on a read side. This is because the CPU 201 generates the Sync packet in the memory unit 202, and the DMA unit 205 transfers the generated Sync packet to the communication IF unit 203. On the other hand, because the secondary terminal receives the Sync packet of the PTP, the detection of the Sync packet of the PTP is performed in a channel on a write side.

In a case where values of these regions match expected values, the write data channel analysis unit 602 changes an execution result to information indicating “match”, and in a case where values of these regions do not match expected values, the write data channel analysis unit 602 keeps the execution result as information indicating “mismatch”.

Because the patterns 1 to 3 include a case where match with expected values is required in a plurality of regions, and the regions have a plurality of bytes, the write data channel analysis unit 602 separately manages an execution result for every one byte or less. That is, in the case of the pattern 1, because determination is required in two regions and expected values of two bytes+four bits in total are compared, the write data channel analysis unit 602 manages three execution results (two in the Ether Type region and one in the message Type region).

Even in a case where the data from the position identified in step S703, to the last of an effective region of the data signal 305c includes a part of regions to be determined, the write data channel analysis unit 602 performs determination in a region up to an included portion. As a matter of course, an execution result may be held for each region.

In step S706, the write data channel analysis unit 602 adds data to the offset by a data amount from the position identified in step S703, to the last of an effective region of the data signal 305c, and the processing proceeds to step S707. By holding a position in the packet where the current position has reached, as the offset, the write data channel analysis unit 602 can determine where an effective head data position of a next data signal 305c starts in the packet.

In step S707, the write data channel analysis unit 602 determines whether the value of the last signal 308c is “1”. The value “1” of the last signal 308c is a value indicating the last of data. In a case where the value of the last signal 308c is “1” (YES in step S707), the processing proceeds to step S708. In a case where the value of the last signal 308c is not “1” (NO in step S707), the processing returns to step S702. In a case where the value of the last signal 308c is “1”, the time management unit 206 determines that the current position has reached end data of the packet.

In step S708, the write data channel analysis unit 602 determines all conditions for determining a packet to be a PTP packet, and determines whether all execution results indicate “match”. In a case where all execution results indicate “match” (YES in step S708), the processing proceeds to step S709. In a case where all execution results do not indicate “match” (NO in step S708), the processing proceeds to step S710. For example, in the case of the pattern 1, the write data channel analysis unit 602 determines whether all of the three execution results indicate “match”.

In step S709, because the write data channel analysis unit 602 functions as a detection unit and detects the writing of a PTP packet, the write data channel analysis unit 602 outputs the write detection notification 608 to the time holding unit 606, and the processing proceeds to step S711. That is, the write data channel analysis unit 602 notifies the time holding unit 606 that a PTP packet has been detected. The PTP packet is an example of a predetermined packet.

In step S710, the write data channel analysis unit 602 initializes the offset and the execution result, and the processing proceeds to step S711.

In step S711, the write data channel analysis unit 602 determines whether an analysis stop instruction has been received from the CPU 201. In a case where the analysis stop instruction has been received (YES in step S711), the processing proceeds to step S712 and the flow illustrated in FIG. 7 ends. In a case where the analysis stop instruction has not been received (NO in step S711), the processing returns to step S702.

Through the above-described processing, the write data channel analysis unit 602 performs the detection of a PTP packet from the monitoring signal 207 of the write data channel 402, and notifies the time holding unit 606 of the detection. If a state with the valid signal 304c=1 and the ready signal 307c=1 continues until the value of the last signal 308c becomes “1”, the data signal 305c received at the time is determined to be data of the same packet, and if the value of the last signal 308c becomes “1”, the time point is determined to be a packet break.

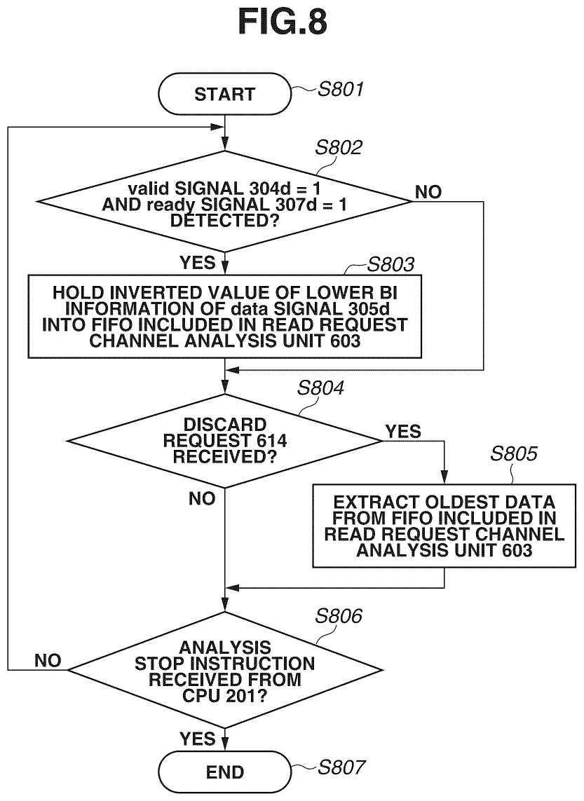

Next, an operation flow of the read request channel analysis unit 603 will be described with reference to FIG. 8. In this flow, the start of the processing in step S801 is performed when the power of the digital camera 101 is turned on and an analysis start instruction is detected by the CPU 201. This flow operates based on a clock signal supplied to the read request channel analysis unit 603, and operates from steps S802 to S802 (return in the case of NO in step S806) or from steps S802 to S807 in one cycle. As a matter of course, the processing of this flow may be operated in a plurality of cycles by dividing the processing into a plurality of blocks and pipeline-operating the processing.

The read request channel analysis unit 603 inputs the monitoring signal 207 of the read request channel 404. The read request channel 404 is a channel for transmitting a packet read from the memory unit 202, to the outside via the communication IF unit 203.

In step S802, the read request channel analysis unit 603 determines whether the valid signal 304d=1 and the ready signal 307d=1 have been detected. In a case where the valid signal 304d=1 and the ready signal 307d=1 have been detected (YES in step S802), the processing proceeds to step S803. In a case where the valid signal 304d=1 and the ready signal 307d=1 have not been detected (NO in step S802), the processing proceeds to step S804.

In step S803, the read request channel analysis unit 603 holds an inverted value of lower bit information of the data signal 305d into the FIFO_A included in the read request channel analysis unit 603, and the processing proceeds to step S804. The data signal 305d indicates address information of data to be read. As the lower bit information, if a data width of the read request channel 404 is 64 bits, lower 3-bit information is used, and if a data width is 128 bits, lower 4-bit information is used. That is, the lower bit information indicates a value satisfying a data width (bit)=8×2 of the number of lower bits.

Information stored in the FIFO_A is output to the read response channel analysis unit 604 as the head byte enable information 609.

In step S804, the read request channel analysis unit 603 determines whether the discard request 611 has been received. In a case where the discard request 611 has been received (YES in step S804), the processing proceeds to step S805. In a case where the discard request 611 has not been received (NO in step S804), the processing proceeds to step S806.

In step S805, the read request channel analysis unit 603 extracts the oldest data from the FIFO_A included in the read request channel analysis unit 603, and the processing proceeds to step S806.

In step S806, the read request channel analysis unit 603 determines whether an analysis stop instruction has been received from the CPU 201. In a case where the analysis stop instruction has been received (YES in step S806), the processing proceeds to step S807 and the flow illustrated in FIG. 8 ends. In a case where the analysis stop instruction has not been received (NO in step S806), the processing returns to step S802.

Through the above-described processing, the read request channel analysis unit 603 calculates the head byte enable information 609 of read data from the monitoring signal 207 of the read request channel 404. As described above, information stored in the FIFO_A is output to the read response channel analysis unit 604 as the head byte enable information 609.

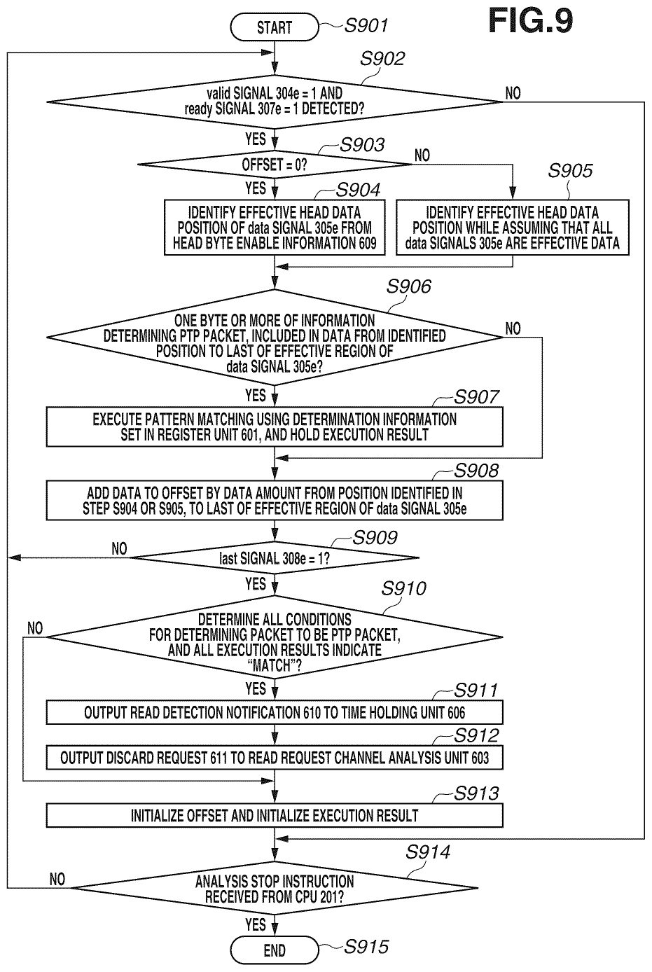

Next, an operation flow of the read response channel analysis unit 604 will be described with reference to FIG. 9. In this flow, the start of the processing in step S901 is performed when the power of the digital camera 101 is turned on and an analysis start instruction is detected by the CPU 201.

Similarly to the operation flow illustrated in FIG. 7, the processing is started in a state in which an offset of a variable and an execution result that are to be used in this flow are initialized. A default value of the offset is set to 0, and a default value of the execution result is set to information indicating “mismatched”.

This flow operates based on a clock signal supplied to the write data channel analysis unit 602, and operates from steps S902 to S902 (return in the case of NO in step S909 or S914) or from steps S902 to S915 in one cycle. As a matter of course, the processing of this flow may be operated in a plurality of cycles by dividing the processing into a plurality of blocks and pipeline-operating the processing.

The read response channel analysis unit 604 inputs the monitoring signal 207 of the read response channel 405. The read response channel 405 is a channel for transmitting a packet read from the memory unit 202, to the outside via the communication IF unit 203.

In step S902, the read response channel analysis unit 604 determines whether the valid signal 304e=1 and the ready signal 307e=1 have been detected. In a case where the valid signal 304e=1 and the ready signal 307e=1 have been detected (YES in step S902), the processing proceeds to step S903. In a case where the valid signal 304e=1 and the ready signal 307e=1 have not been detected (NO in step S902), the processing proceeds to step S914.

In step S903, the read response channel analysis unit 604 determines whether an offset of a variable is set to 0. In a case where an offset of a variable is set to 0 (YES in step S903), the processing proceeds to step S904. In a case where an offset of a variable is not set to 0 (NO in step S903), the processing proceeds to step S905.

In step S904, the read response channel analysis unit 604 identifies an effective head data position of the data signal 305e from the head byte enable information 609, and the processing proceeds to step S906. For example, if a data width is 64 bits and the head byte enable information 609 is 0xFE, among zeroth to (lower bit side) to seventh (higher bit side) bytes, a first byte becomes the effective head data position.

In step S905, the read response channel analysis unit 604 identifies an effective head data position while assuming that all the data signals 305e correspond to effective data, and the processing proceeds to step S906. For example, if a data width is 64 bits, a zeroth byte (lower bit side) becomes the effective head data position.

In step S906, the read response channel analysis unit 604 determines whether one byte or more of information determining a PTP packet is included in data from the position identified in step S904 or S905, to the last of an effective region of the data signal 305e. In a case where one byte or more of information determining a PTP packet is included (YES in step S906), the processing proceeds to step S907. In a case where one byte or more of information determining a PTP packet is not included (NO in step S906), the processing proceeds to step S908. Because a determination method is similar to that in the processing in step S704 of FIG. 7, the description will be omitted.

In step S907, the read response channel analysis unit 604 executes pattern matching on the information determining a PTP packet in step S906, using determination information set in the register unit 601, holds an execution result, and the processing proceeds to step S908. Because the determination information, the pattern matching, and the execution result are similar to those in the processing in step S705 of FIG. 7, the description will be omitted.

In step S908, the read response channel analysis unit 604 adds data to the offset by a data amount from the position identified in step S904 or S905, to the last of an effective region of the data signal 305e, and the processing proceeds to step S909.

In step S909, the read response channel analysis unit 604 determines whether the value of the last signal 308e is “1”. In a case where the value of the last signal 308e is “1” (YES in step S909), the processing proceeds to step S910. In a case where the value of the last signal 308e is not “1” (NO in step S909), the processing returns to step S902. In a case where the value of the last signal 308e is “1”, the time management unit 206 determines that the current position has reached end data of the packet.

In step S910, the read response channel analysis unit 604 determines all conditions for determining a packet to be a PTP packet, and determines whether all execution results indicate “match”. In a case where all execution results indicate “match” (YES in step S910), the processing proceeds to step S911. In a case where all execution results do not indicate “match” (NO in step S910), the processing proceeds to step S913.

In step S911, because the read response channel analysis unit 604 functions as a detection unit and detects the reading of a PTP packet, the read response channel analysis unit 604 outputs the read detection notification 610 to the time holding unit 606, and the processing proceeds to step S912. That is, the read response channel analysis unit 604 notifies the time holding unit 606 that a PTP packet has been detected. The PTP packet is an example of a predetermined packet.

In step S912, the read response channel analysis unit 604 outputs the discard request 611 to the read request channel analysis unit 603, and the processing proceeds to step S913.

In step S913, the read response channel analysis unit 604 initializes the offset and the execution result, and the processing proceeds to step S914.

In step S914, the read response channel analysis unit 604 determines whether an analysis stop instruction has been received from the CPU 201. In a case where an analysis stop instruction has been received (YES in step S914), the processing proceeds to step S915 and the flow illustrated in FIG. 9 ends. In a case where an analysis stop instruction has not been received (NO in step S914), the processing returns to step S902.

Through the above-described processing, the read response channel analysis unit 604 performs the detection of a PTP packet from the monitoring signal 207 of the read response channel 405, and notifies the time holding unit 606 of the detection. If a state with the valid signal 304e=1 and the ready signal 307e=1 continues until the value of the last signal 308e becomes “1”, the data signal 305e received at the time is determined to be data of the same packet, and if the value of the last signal 308e becomes “1”, the time point is determined to be a packet break.

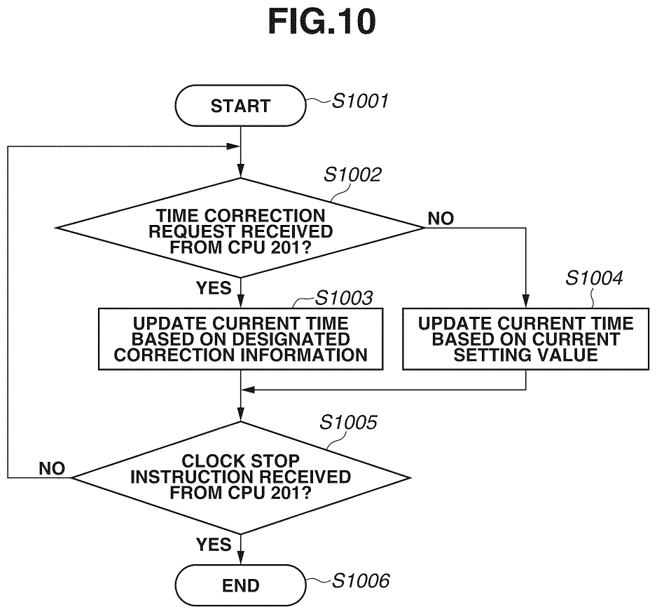

Next, an operation flow of the clock unit 605 will be described with reference to FIG. 10. In this flow, the start of the processing in step S1001 is performed when the power of the digital camera 101 is turned on and a clock start instruction is detected by the CPU 201.

This flow operates based on a clock signal supplied to the clock unit 605, and operates from steps S1002 to S1002 (return in the case of NO in step S1005) or from steps S1002 to S1006 in one cycle. As a matter of course, the processing of this flow may be operated in a plurality of cycles by dividing the processing into a plurality of blocks and pipeline-operating the processing.

In step S1002, the clock unit 605 determines whether a time correction request has been received from the CPU 201. In a case where a time correction request has been received (YES in step S1002), the processing proceeds to step S1003. In a case where a time correction request has not been received (NO in step S1002), the processing proceeds to step S1004.

In step S1003, the clock unit 605 updates the current time based on correction information designated by an instruction, and the processing proceeds to step S1005.

In step S1004, the clock unit 605 updates the current time using an increment value of a counter that is set in the register unit 601, and the processing proceeds to step S1005.

In step S1005, the clock unit 605 determines whether a clock stop instruction has been received from the CPU 201. In a case where a clock stop instruction has been received (YES in step S1005), the processing proceeds to step S1006 and the flow illustrated in FIG. 10 ends. In a case where a clock stop instruction has not been received (NO in step S1005), the processing returns to step S1002.

Through the above-described processing, the clock unit 605 updates the time based on an instruction from the CPU 201, or updates the time using a set increment value. As described above, because the clock unit 605 constantly outputs a time manages by itself, as the current time 612, the time holding unit 606 and the timing signal generation unit 620 can always refer to the current time 612.

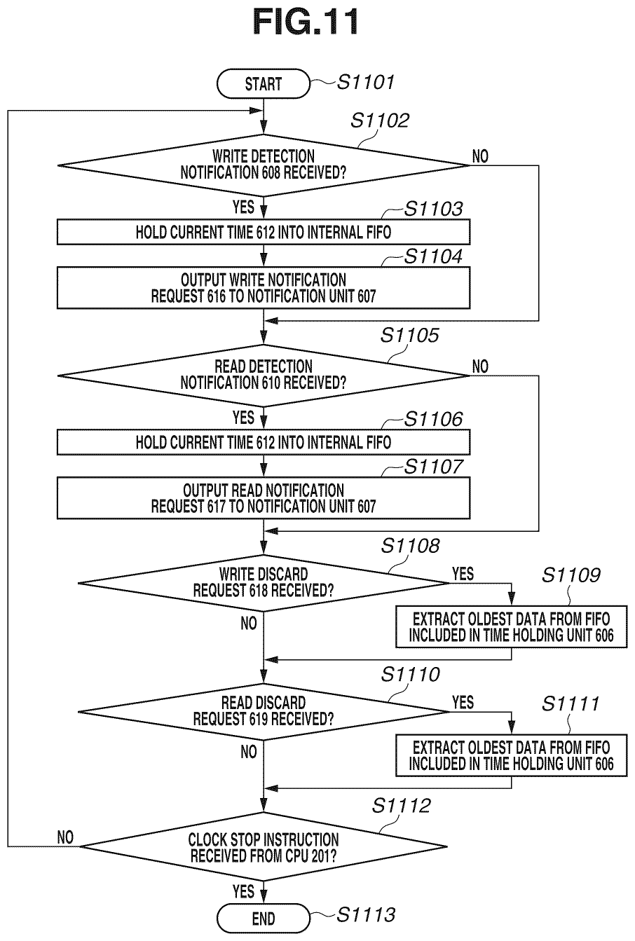

Next, an operation flow of the time holding unit 606 will be described with reference to FIG. 11. In this flow, the start of the processing in step S1101 is performed when the power of the digital camera 101 is turned on and a clock start instruction is detected by the CPU 201.

This flow operates based on a clock signal supplied to the time holding unit 606, and operates from steps S1102 to S1102 (return in the case of NO in step S1112) or from steps S1102 to S1113 in one cycle.

In step S1102, the time holding unit 606 determines whether the write detection notification 608 has been received. In a case where the write detection notification 608 has been received (YES in step S1102), the processing proceeds to step S1103. In a case where the write detection notification 608 has not been received (NO in step S1102), the processing proceeds to step S1105.

In step S1103, the time holding unit 606 holds the current time 612 of the clock unit 605 into the FIFO_B (not illustrated) included in the time holding unit 606, outputs the value of the FIFO_B to the register unit 601 as the write hold time 614, and the processing proceeds to step S1104.

In step S1104, the time holding unit 606 outputs the write notification request 616 to the notification unit 607, and the processing proceeds to step S1105.

In step S1105, the time holding unit 606 determines whether the read detection notification 610 has been received. In a case where the read detection notification 610 has been received (YES in step S1105), the processing proceeds to step S1106. In a case where the read detection notification 610 has not been received (NO in step S1105), the processing proceeds to step S1108.

In step S1106, the time holding unit 606 holds the current time 612 of the clock unit 605 into the FIFO_C (not illustrated) included in the time holding unit 606, outputs the value of the FIFO_C to the register unit 601 as the read hold time 615, and the processing proceeds to step S1108.

In step S1107, the time holding unit 606 outputs the read notification request 617 to the notification unit 607, and the processing proceeds to step S1108.

In step S1108, the time holding unit 606 determines whether the write discard request 618 has been received. In a case where the write discard request 618 has been received (YES in step S1108), the processing proceeds to step S1109. In a case where the write discard request 618 has not been received (NO in step S1108), the processing proceeds to step S1110.

In step S1109, the time holding unit 606 extracts the oldest data from the FIFO_B (not illustrated) included in the time holding unit 606, and the processing proceeds to step S1110.

In step S1110, the time holding unit 606 determines whether the read discard request 619 has been received. In a case where the read discard request 619 has been received (YES in step S1110), the processing proceeds to step S1111. In a case where the read discard request 619 has not been received (NO in step S1110), the processing proceeds to step S1112.

In step S1111, the time holding unit 606 extracts the oldest data from the FIFO_C (not illustrated) included in the time holding unit 606, and the processing proceeds to step S1112.

In step S1112, the time holding unit 606 determines whether a clock stop instruction has been received from the CPU 201. In a case where a clock stop instruction has been received (YES in step S1112), the processing proceeds to step S1113 and the flow in FIG. 11 ends. In a case where a clock stop instruction has not been received (NO in step S1112), the processing returns to step S1102.

Through the above-described processing, when a notification request is received, the time holding unit 606 stores the current time 612 into the FIFO_B or the FIFO_C included in the time holding unit 606. The two FIFO_B and FIFO_C continue to output oldest data until extraction processing is performed, and their values are output to the register unit 601 as the write hold time 614 and the read hold time 615.

The CPU 201 reads the write hold time 614 or the read hold time 615 from the register unit 601 at a timing at which the notification signal 208 generated by the notification unit 607 is detected, or at a timing at which DMA transfer completion of a PTP packet is detected. After the reading, the CPU 201 issues a discard command to the register unit 601 to delete an unnecessary time stamp.

The register unit 601 generates the write discard request 618 or the read discard request 619 based on the discard command, and oldest data (the write hold time 614 or the read hold time 615 that has been read) is deleted from the FIFO_B or the FIFO_C.

In the present exemplary embodiment, a wireless communication environment is assumed, but similar processing can be executed also under a wire communication environment. As a difference, a position from a packet head where a header region for detection as a PTP packet appears changes. The time management unit 206 is enabled to designate a wireless header length, and in a case where the digital camera 101 is used in a wired system, switching may be performed by setting 0 as a wireless header length.

In the present exemplary embodiment, an Ethernet frame is described on the assumption of the Ethernet II, but may have a format of an Ethernet header defined in the Institute of Electrical and Electronics Engineers (IEEE) 802.3. In this case, because the position of the Ether Type region is changed to a Length region, the Ether Type region is not to be compared as-is with an expected value. In a case where the format of the Ethernet header defined in the IEEE 802.3 is used, in order to designate a protocol of a higher layer, a logical link control (LLC) header and a subnetwork access protocol (SNAP) header are added and used. Accordingly, in a case where the format of the Ethernet header defined in the IEEE 802.3 is used, an Ethernet header, an LLC header, a SNAP header, a PTP header, and a PTP payload are included in this order from the head of the packet. The SNAP header includes a protocol identifier (PID) region, and the PID region plays a role equivalent to the Ether Type region in the Ethernet II. Because a value of the PID indicates a value equivalent to the Ether Type (if an upper protocol is IPv4, 0x0800), an expected value needs not be changed in accordance with the format of the Ethernet header. It is sufficient that a length from the head of the packet up to a position where the Ether Type region or the PID region appears can be designated for the time management unit 206.

FIG. 14 is a diagram illustrating PTP time synchronization processing. The digital camera 101a operates as a time synchronization source (primary terminal) in time synchronization, and the digital camera 101b operates as a time synchronization destination (secondary terminal).

In step S1401, the digital camera 101a transmits a synchronization packet Sync to the digital camera 101b at regular intervals. When the digital camera 101a transmits the synchronization packet Sync, the digital camera 101a holds a transmission time stamp t1 indicating the transmission time. In this case, in step S911 of FIG. 9, the read response channel analysis unit 604 outputs the read detection notification 610 to the time holding unit 606. In step S1106 of FIG. 11, the time holding unit 606 holds the current time 612 into the FIFO_C included in the time holding unit 606, and outputs the value of the FIFO_C to the register unit 601 as the read hold time 615. The read hold time 615 corresponds to the transmission time stamp t1 in FIG. 14.

When the digital camera 101b receives the synchronization packet Sync, the digital camera 101b holds a reception time stamp t2 indicating the reception time. In this case, in step S709 of FIG. 7, the write data channel analysis unit 602 outputs the write detection notification 608 to the time holding unit 606. In step S1103 of FIG. 11, the time holding unit 606 holds the current time 612 into the FIFO_B included in the time holding unit 606, and outputs the value of the FIFO_B to the register unit 601 as the write hold time 614. The write hold time 614 corresponds to the reception time stamp t2 in FIG. 14.

Next, in step S1402, the digital camera 101a transmits a synchronization packet Follow_Up including the transmission time stamp t1 at which the synchronization packet Sync has been transmitted, to the digital camera 101b. When the digital camera 101b receives the synchronization packet Follow_Up, the digital camera 101b holds the transmission time stamp t1 included in the synchronization packet Follow_Up.

A method by which the digital camera 101a transmits the transmission time stamp t1 of the synchronization packet Sync by including the transmission time stamp t1 in the synchronization packet Follow_Up has been described. Aside from this method, the digital camera 101a may transmit the transmission time stamp t1 of the synchronization packet Sync by including the transmission time stamp t1 in the synchronization packet Sync, instead of including the transmission time stamp t1 in the synchronization packet Follow_Up.

Next, in step S1403, the digital camera 101b transmits a synchronization packet delay_req to the digital camera 101a. When the digital camera 101b transmits the synchronization packet delay_req, the digital camera 101b holds a transmission time stamp t3 of the synchronization packet delay_req. In this case, in step S911 of FIG. 9, the read response channel analysis unit 604 outputs the read detection notification 610 to the time holding unit 606. In step S1106 of FIG. 11, the time holding unit 606 holds the current time 612 into the FIFO_C included in the time holding unit 606, and outputs the value of the FIFO_C to the register unit 601 as the read hold time 615. The read hold time 615 corresponds to the transmission time stamp t3 in FIG. 14.

When the digital camera 101a receives the synchronization packet delay_req, the digital camera 101a holds a reception time stamp t4 of the synchronization packet delay_req. In this case, in step S709 of FIG. 7, the write data channel analysis unit 602 outputs the write detection notification 608 to the time holding unit 606. In step S1103 of FIG. 11, the time holding unit 606 holds the current time 612 into the FIFO_B included in the time holding unit 606, and outputs the value of the FIFO_B to the register unit 601 as the write hold time 614. The write hold time 614 corresponds to the reception time stamp t4 in FIG. 14.

Next, in step S1404, the digital camera 101a transmits a synchronization packet delay_resp to the digital camera 101b. At this time, the digital camera 101a transmits the reception time stamp t4 of the synchronization packet delay_req to the digital camera 101b by including the reception time stamp t4 in the synchronization packet delay_resp.

When the digital camera 101b receives the synchronization packet delay_resp, the digital camera 101b holds the reception time stamp t4 included in the synchronization packet delay_resp.

From the communication of the synchronization packets Sync, follow_up, delay_req, and delay_resp in steps S1401 to S1404, the CPU 201 of the digital camera 101b calculates an average transmission delay time Td by the following formula based on the time stamps t1 to t4.

$$Td = \{ ( t 2 - t 1 ) + ( t 4 - t 3 ) \} / 2$$

Next, the CPU 201 of the digital camera 101b calculates a correction value Tc by the following formula based on the average transmission delay time Td.

$$Tc = ( t 2 - t 1 ) - td$$

The correction value Tc indicates a deviation amount of the current time 612 of the clock unit 605 of the digital camera 101b from the current time 612 of the clock unit 605 of the digital camera 101a. The CPU 201 of the digital camera 101b transmits a request for time correction by the correction value Tc to the clock unit 605. In step S1003 of FIG. 10, the clock unit 605 of the digital camera 101b functions as a correction unit, and corrects the current time 612 indicating a counter value of the clock unit 605, in such a manner that a value obtained by subtracting the correction value Tc from the current time 612 becomes a corrected current time 612.

The current time 612 of the clock unit 605 of the digital camera 101b accordingly becomes the same as the current time 612 of the clock unit 605 of the digital camera 101a. Similarly, the current time 612 of the clock unit 605 of the digital camera 101c becomes the same as the current time 612 of the clock unit 605 of the digital camera 101a.

The timing signal generation unit 620 in FIG. 6 generates the timing signal 211 based on the current time 612 of the clock unit 605. The imaging unit 210 in FIG. 2 performs image capturing based on the timing signal 211.

Because the timing signals 211 of the digital cameras 101a to 101c are generated at the same timing, the imaging units 210 of the digital cameras 101a to 101c can perform image capturing at the same timing.

As described above, according to the present exemplary embodiment, by the processing in FIGS. 7 to 11, a time required for a PTP packet to move from the communication IF unit (communication chip or NIC) 203 to the memory unit (DRAM, etc.) 202 in FIG. 2, and a processing time of the CPU 201 that is required in response to the movement are no longer included in a time stamp.

Even in a case where the communication IF unit (communication chip or NIC) 203 does not have a time stamp function, the time management unit 206 acquires a time stamp near the boundary with a lower layer, high synchronization accuracy among the plurality of digital cameras 101a to 101c can be obtained.

In the first exemplary embodiment, the time management unit 206 connects to the system bus 209, and performs the detection of a PTP packet for signals of a connection IF between the system bus 209 and the DMA unit 205.

In a second exemplary embodiment, a configuration in which a time management unit 206 is incorporated into a DMA unit 205 will be described.

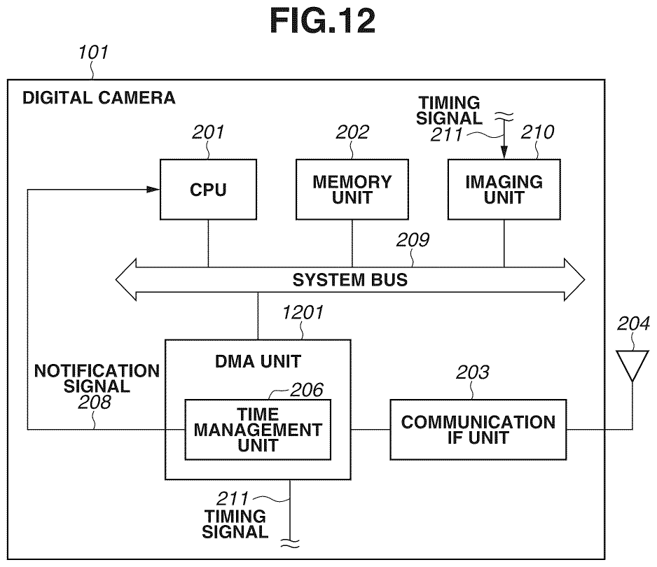

FIG. 12 illustrates a configuration example of a digital camera 101 according to the second exemplary embodiment. In FIG. 12, the same components as those in FIG. 2 are assigned the same reference numerals, and the description will be omitted.

The digital camera 101 includes a CPU 201, a memory unit 202, a communication IF unit 203, an antenna 204, a system bus 209, an imaging unit 210, and a DMA unit 1201. The DMA unit 1201 includes a time management unit 206.

In the second exemplary embodiment, the time management unit 206 is incorporated into the DMA unit 1201, and the detection of a PTP packet is performed by monitoring an internal signal. Similarly to the first exemplary embodiment, if the time management unit 206 detects a PTP packet and holds a time stamp, the time management unit 206 outputs the notification signal 208 to the CPU 201. In a case where a time of a clock included in the time management unit 206 has reached a designated time, the time management unit 206 also outputs the timing signal 211. The DMA unit 1201 further has a function equivalent to that in the first exemplary embodiment.

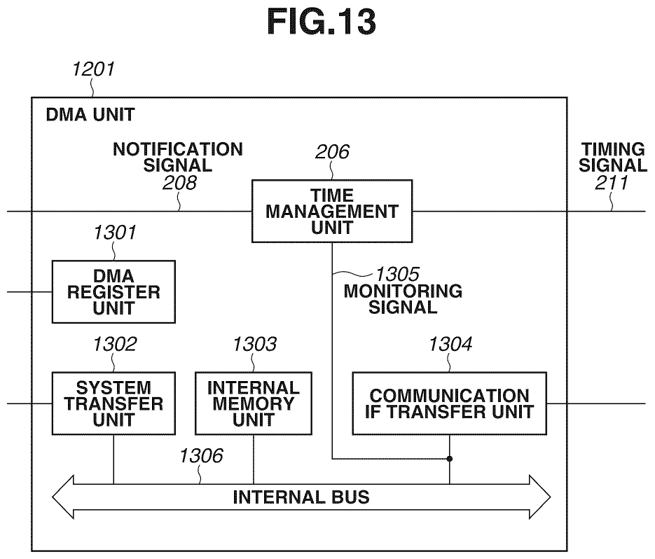

FIG. 13 illustrates a configuration example of the DMA unit 1201 illustrated in FIG. 12. The DMA unit 1201 includes a DMA register unit 1301, a system transfer unit 1302, an internal memory unit 1303, a communication IF transfer unit 1304, the time management unit 206, and an internal bus 1306.

The DMA register unit 1301 connects with the system bus 209, and manages control information of the DMA unit 1201 and the time management unit 206 that is set by the CPU 201. The control information can be always referred to by each internal functional block. In the first exemplary embodiment, the register unit 601 exists in the time management unit 206, but may coexist with the DMA register unit 1301, or these may be integrated into one functional block.

The system transfer unit 1302 is connected to the system bus 209 and the internal bus 1306, and performs data transfer between the memory unit 202 and the internal memory unit 1303.

The internal memory unit 1303 is connected to the internal bus 1306, and used as a temporary storage of a packet received from the communication IF unit 203 or a packet to be delivered to the communication IF unit 203.

The communication IF transfer unit 1304 is connected to the communication IF unit 203 and the internal bus 1306, and performs data transfer between the communication IF unit 203 and the internal memory unit 1303.

The protocol of an IF connecting with the internal bus 1306, and the protocol of an IF connecting with the system bus 209 may be the same, or may be different. In another case, signals used in the first exemplary embodiment need to be mapped to monitoring signals 1305 to be input to the time management unit 206.

According to an exemplary embodiment of the present disclosure, it is possible to hold a time at which a packet is received, or a time at which a packet is transmitted, with a small error.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)?), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-066166, which was filed on Apr. 16, 2024 and which is hereby incorporated by reference herein in its entirety.

What is claimed is:

1. A communication apparatus comprising:
a detection unit configured to detect writing or reading of a predetermined packet based on a signal of a channel for writing a packet received from an outside into a memory unit, or a signal of a channel for transmitting a packet read from a memory unit to an outside; and
a time holding unit configured to, in a case where writing or reading of the predetermined packet is detected, hold a current time of a clock unit as a write hold time or a read hold time.

2. The communication apparatus according to claim 1, wherein the predetermined packet is a precision time protocol (PTP) packet.

3. The communication apparatus according to claim 2, wherein, in a case where values of an Ether Type region of an Ethernet header and a message Type region of a PTP header match expected values, the detection unit determines that writing or reading of the PTP packet has been detected.

4. The communication apparatus according to claim 2, wherein, in a case where values of an Ether Type region of an Ethernet header, a Protocol region of an Internet Protocol version 4(IPv4 ) header, a Destination Port region of a user datagram protocol (UDP) header, and a message Type region of a PTP header match expected values, the detection unit determines that writing or reading of the PTP packet has been detected.

5. The communication apparatus according to claim 2, wherein, in a case where values of an Ether Type region of an Ethernet header, a Next Header region of an Internet Protocol version 6(IPv6 ) header, a Destination Port region of a UDP header, and a message Type region of a PTP header match expected values, the detection unit determines that writing or reading of the PTP packet has been detected.

6. The communication apparatus according to claim 2, wherein the detection unit detects writing or reading of the PTP packet based on a value of a region from a head of the PTP packet to a message Type region of a PTP header.

7. The communication apparatus according to claim 1, wherein the detection unit detects writing or reading of the predetermined packet after a value of a signal of the channel becomes a value indicating an end of data.

8. The communication apparatus according to claim 1,
wherein the channel for writing a packet received from an outside into a memory unit is a write data channel, and
wherein the detection unit identifies a head position of effective data based on byte enable information of the write data channel, and detects writing of the predetermined packet based on the effective data.

9. The communication apparatus according to claim 1,
wherein the channel for transmitting a packet read from a memory unit to an outside includes a read request channel and a read response channel, and
wherein the detection unit identifies a head position of effective data of the read response channel based on address information of the read request channel, and detects reading of the predetermined packet based on the effective data.

10. The communication apparatus according to claim 1, wherein the channel is a channel between a direct memory access (DMA) unit and a bus.

11. The communication apparatus according to claim 10, wherein the detection unit and the time holding unit are provided inside the DMA unit.

12. The communication apparatus according to claim 2,
wherein the detection unit includes a first detection unit configured to detect writing of the PTP packet based on a signal of the channel for writing a packet received from an outside into a memory unit, and a second detection unit configured to detect reading of the PTP packet based on a signal of the channel for transmitting a packet read from a memory unit to an outside,
wherein, in a case where writing of the PTP packet is detected, the time holding unit holds a current time of the clock unit as a write hold time, and
wherein, in a case where reading of the PTP packet is detected, the time holding unit holds a current time of the clock unit as a read hold time.

13. The communication apparatus according to claim 12, further comprising the clock unit, wherein the clock unit is configured to correct a current time of the clock unit based on the write hold time and the read hold time.

14. The communication apparatus according to claim 13, further comprising:
a timing signal generation unit configured to generate a timing signal based on a current time of the clock unit; and
an imaging unit configured to perform image capturing based on the timing signal.

15. A processing method for a communication apparatus, the processing method comprising:
detecting writing or reading of a predetermined packet based on a signal of a channel for writing a packet received from an outside into a memory unit, or a signal of a channel for transmitting a packet read from a memory unit to an outside; and
in a case where writing or reading of the predetermined packet is detected, holding a current time of a clock unit as a write hold time or a read hold time.

16. A non-transitory computer-readable storage medium storing instructions that, when executed by a computer, cause the computer to perform a processing method for a communication apparatus, the processing method comprising:
detecting writing or reading of a predetermined packet based on a signal of a channel for writing a packet received from an outside into a memory unit, or a signal of a channel for transmitting a packet read from a memory unit to an outside; and
in a case where writing or reading of the predetermined packet is detected, holding a current time of a clock unit as a write hold time or a read hold time.
